(19) United States
(12) Patent Application Publication
(10) Pub. No.: US 2003/0047898 A1
(43) Pub. Date: Mar. 13, 2003

(54) Hydraulic anti-roll system

(76) Inventors: Imre Nagy, Eching (DE); Hartmut Bruns, Muenchen (DE); Andreas Benedek, Unterschleissheim (DE); Albert Van Der Knaap, Krimpen aan den Yssel (NL)

Correspondence Address: CROWELL & MORING LLP, INTELLECTUAL PROPERTY GROUP, P.O. BOX 14300, WASHINGTON, DC, 20044-4300, US

(21) Appl. No.: 09/959,597

(22) PCT Filed: Feb. 7, 2001
(86) PCT No.: PCT/EP01/01298

(30) Foreign Application Priority Data
Mar. 1, 2000 (DE) 100 09 918.1

(51) Int. Cl. B60G 9/04

(52) U.S. Cl. 280/124.157

(57) ABSTRACT

The invention relates to a hydraulic stabilizing system, particularly for a chassis of a vehicle, which has a tank for hydraulic fluid and a pump which are connected by way of corresponding hydraulic lines with front and rear axle actuators, a directional valve being connected in front of the actuators, and the pressure at the front axle actuator being controllable such that it is greater than or equal to the pressure at the rear axle actuator. The invention is characterized in that, between the directional valve for the front axle actuator and the pump, a fail-safe valve is provided and, between the fail-safe valve and the directional valve in the front axle forward flow line, a pressure sensor is provided.

The invention relates to a hydraulic stabilizing system, particularly for a chassis of a vehicle, which has a tank for hydraulic fluid and a pump which are connected by way of corresponding hydraulic lines with front and rear axle actuators, a directional valve being connected in front of the actuators, and the pressure at the front axle actuator being controllable such that it is greater than or equal to the pressure at the rear axle actuator. With respect to the prior art, reference is made to German Patent Document DE 196 49 187 A1, in addition to German Utility Model 296 19 567.

From the prior art, hydraulic stabilizing systems for vehicles are known which have the purpose of hardening the vehicle suspension, particularly when the wheels assigned to an axle compress and rebound on one side. As a result, a rolling of the vehicle can be avoided. In this case, the known stabilizing systems have actuators, particularly hydraulic oscillating motors, which interact with two stabilizer sections respectively such that a mutual rotation is caused. The thus generated torques counteract a compression of a wheel connected with the stabilizer bar.

German Published Patent Document DE 196 49 187 A1, for example, describes such a hydraulic stabilizing device having a control valve arranged between a pressure line and a fueling line. The control valve can in each case be adjusted from a neutral position into a first and second control position, in which the forward-flow or pressure line is connected with a first working chamber and the return-flow or fueling line is connected with a second working chamber of an actuator or vice versa. Furthermore, a pressure limiting valve or pressure regulating valve is arranged parallel to the control valve between the pressure line and the fueling line. In the neutral position, the control valve connects the pressure line with the fueling line.

German Utility Model DE 296 19 567 U describes a similar stabilizing system for stabilizing the roll of a vehicle which has one front axle and one rear axle actuator respectively, which are each formed by an oscillating motor with two working chambers, a hydraulic line leading into each of these working chambers. In order to cause a stabilization of the roll, by way of a series connection of a so-called fail-safe valve or safety valve and of a so-called change-over valve, one hydraulic line can be connected with a forward flow line and the other hydraulic line can be connected with a return flow line of the actuator. For this purpose, the fail-safe valve must be adjusted by a corresponding control from a current-free blocking position into a pass position, which opens the two hydraulic lines, and the change-over valve must be displaced into one or the other position in which one hydraulic line is connected with the forward flow line and the other hydraulic line is connected with the return flow line. The function of the safety valve or fail-safe valve consists of changing, in the event of a failure of the hydraulic stabilizing system and particularly of the change-over valve, that is, of the pressure regulating valve at the front axle, this system into a defined functioning condition.

In this known prior art, a separate safety or fail-safe valve is arranged for each actuator upstream of the latter, that is, between the assigned change-over or directional valve and the actuator. On the one hand, this results in high expenditures. In addition, in the most unfavorable case, the more important safety valve of the front axle actuator may undesirably remain in its position interrupting the connection between the actuator and the pump—(when the terminals of this valve are in the center position, all connections are separated)—which would result in the fact that the hydraulic pressure in the front axle actuator would be considerably lower than that in the rear axle actuator. Thus, unnoticed, the desired effective actuator pressure difference would be set at the rear axle, whereas, at the front axle, a pressure difference would be reached which is too low or which is lower than at the rear axle. However, as described in German Patent Document DE 196 49 187 A1, the pressure at the front axle should always be larger than or equal to the pressure at the rear axle.

It is therefore an object of the present invention to avoid the above-mentioned disadvantages of the hydraulic stabilizing systems of the prior art and to provide an improved stabilizing system. This improved stabilizing system should permit a secure functioning and a cost-effective production and assembly.

This object is achieved by means of a hydraulic stabilizing system having the characteristics of claim 1. Advantageous further developments of the invention are described in the subclaims.

The present invention provides an improved hydraulic stabilizing system which, as a result of the corresponding arrangement of the preferably single fail-safe valve, which is now arranged in a particularly favorable fashion, permits a particularly secure functioning and a cost-effective production and assembly. The fail-safe valve is connected in front of the so-called directional valve or change-over valve so that, between these two control valves, only one line is subjected to the system pressure. In the event of a defect, that is, when the pressure regulating valve of the front axle or the directional valve is hung in the closed position, the fail-safe valve is switched current-free and a circulating flow is ensured from the pump to the tank.

Since only one line is subjected to the system pressure, it can now be checked by means of a single pressure sensor provided in this front axle forward flow line subjected to the system pressure whether the requirement has been met that the pressure at the front axle actuator should be at least as high as that at the rear axle actuator. Naturally, for this purpose, the pressure at the rear axle actuator should also be measurable at an appropriate point; that is, by means of a pressure comparison between the front axle pressure and the rear axle pressure, it can then be concluded that the controlling of the fail-safe valve is defective.

In the event of a blocked fail-safe valve, an aftersuction of hydraulic medium by or for the front axle actuator can be implemented by way of a return valve or by way of a throttled fueling line. This throttle can be defined corresponding to the results of the chassis tuning. If the fail-safe valve should unintentionally not switch into the correct position, the return valve and/or the throttled fueling line will take over the function that the pressure at the front axle will become higher or will only for a short time be slightly lower than the pressure at the rear axle. In order to be able to detect this defect event, the pressure sensor for the front axle circuit should be arranged between the fail-safe valve and the so-called directional valve.

By means of a hydraulic stabilizing system according to the invention, the occurrence of trapped air in the system and therefore a cavitation in the actuator chambers is generally avoided, particularly also in the blocking position of the fail safe valve. As a result of the corresponding arrangement of the fail-safe valve and the providing of corresponding pressure sensors, the stabilizing system is particularly advantageously suited for detecting the functioning of the fail-safe valve by a plausibility monitoring of pressure signals. Furthermore, by providing pressure sensors in the lines to the actuators, it is ensured that the pressure at the front axle is always greater than or equal to the pressure at the rear axle. In contrast to the prior art known from German Patent Document DE 296 19 567 U1, an additional return valve is not required here. Also, particularly for diagnostic purposes, an additional pressure sensor may be provided between the pump and the fail-safe valve.

Additional further developments and advantages of the invention are explained by means of the description of the embodiments with reference to the attached drawings.

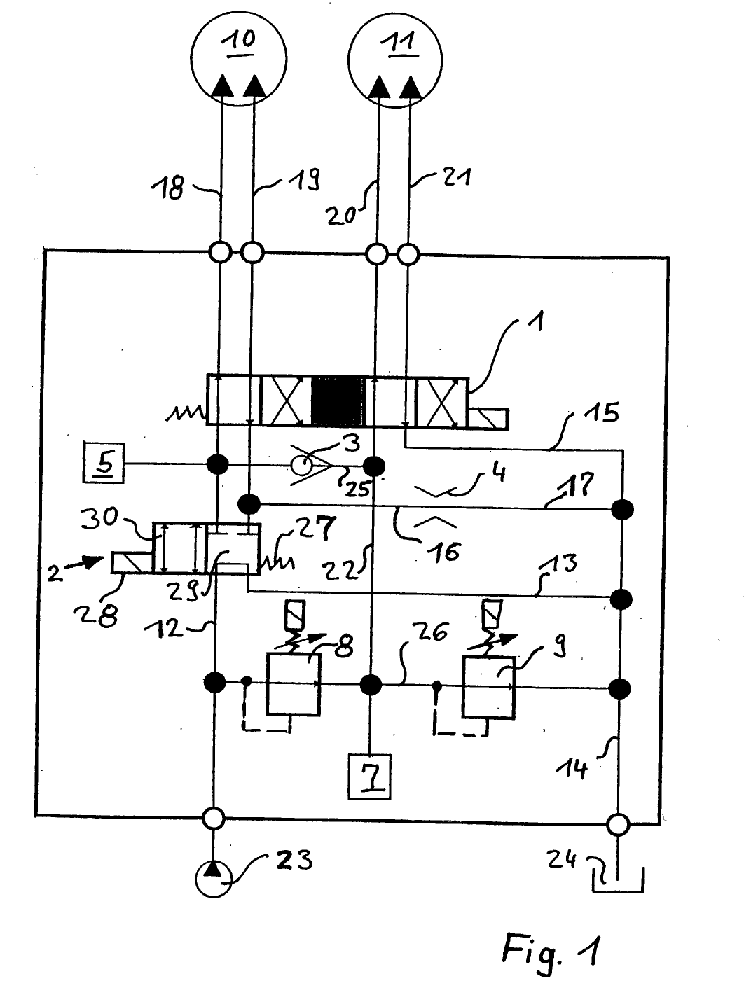

FIG. 1 is a schematic wiring diagram of a current-free stabilizing system according to the present invention;

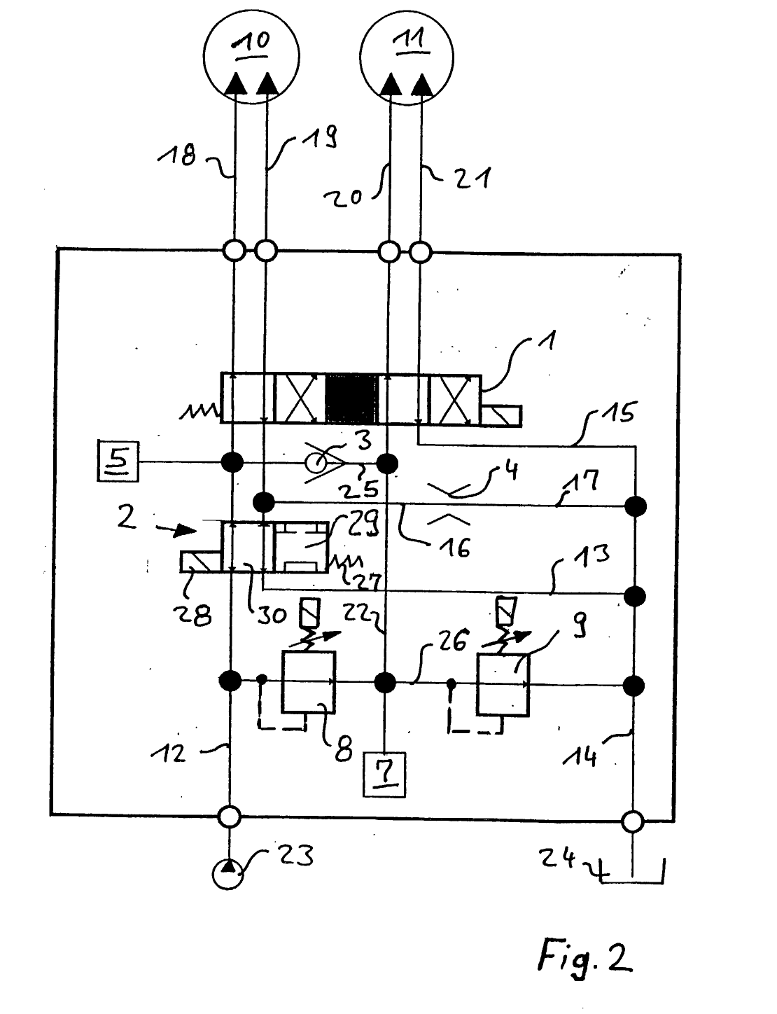

FIG. 2 is a schematic wiring diagram of the stabilizing system according to FIG. 1 with an open fail-safe valve;

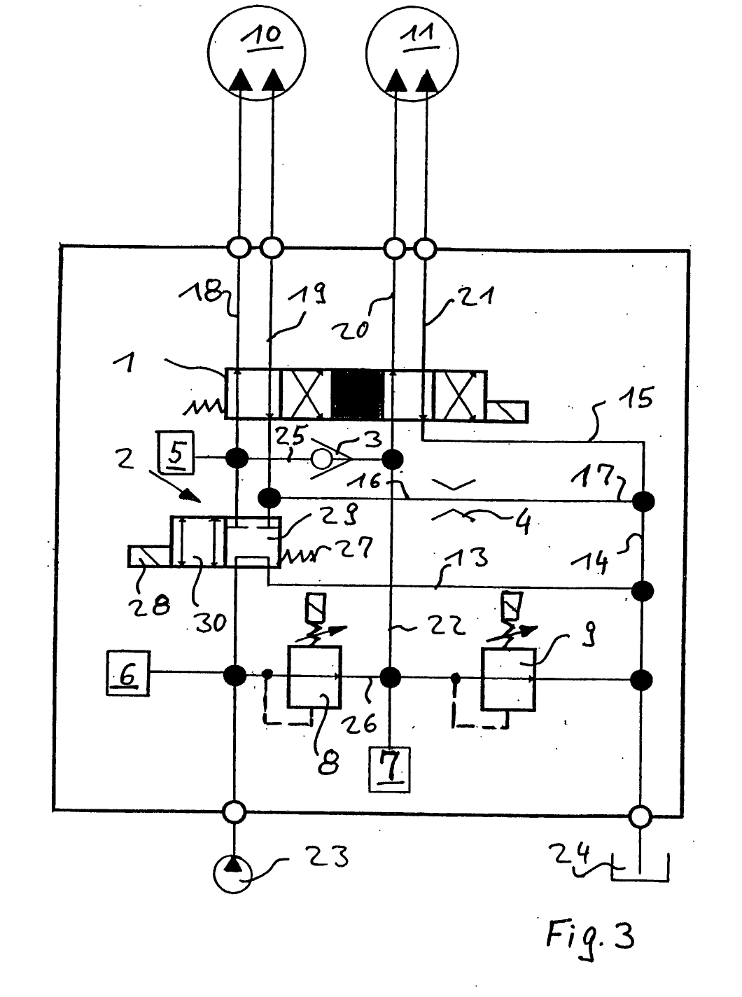

FIG. 3 is a view of an alternative embodiment of a current-free stabilizing system according to the present invention;

FIGS. 1 and 2 show a first embodiment of a stabilizing system according to the invention, in which case a directional valve 1 is in an energized condition, that is, in a connected position. The stabilizing system according to the invention regulates the feeding of hydraulic fluid from a tank 24 to a front axle actuator 10 and to a rear axle actuator 11 which each vary the spring damper behavior of the front axle and of the rear axle respectively of a vehicle with a one-sided excitation. In this case, the hydraulic fluid is delivered by a pump 23 by way of a forward flow line 12 to a so-called fail-safe valve 2 acting as a safety valve.

The fail-safe valve 2 has two positions, specifically a blocking position 29 and a pass position 30. By way of a pressure spring 27, the fail-safe valve 2 is held in a current-free condition in its blocking position. In its position acted upon by current, it is held in the pass position by means of a solenoid 28, as illustrated in FIG. 2. In the current-free blocking position, the hydraulic fluid delivered by the pump 23 arrives by way of a forward-flow line 12 in a return flow line 13 and, from there, flows back into the tank 24 by way of a return flow line 14.

In addition, a branching exists between the pump 23 and the fail-safe valve 2, by way of which branching hydraulic fluid arrives by way of a pressure regulating valve 8 in another branching. The forward flow line 22 for the rear axle starts at this branching, the pressure relevant thereto being adjusted by a pressure regulating valve 9 connected on the output side which, like the pressure regulating valve 8, is constructed as a proportional pressure limiting valve. By means of the pressure regulating valves 8 and 9, the hydraulic pressure is set which is to be applied to the front axle actuator 10.

At the branching between the two pressure regulating valves 8, 9, a pressure sensor 7 is arranged for measuring the pressure level offered to the rear axle actuator 11. In addition, in or on the front axle forward flow line 12 acted upon by the pump 23 by hydraulic pressure when the fail-safe valve 2 is open, a front axle pressure sensor 5 is provided between the fail-safe valve 2 and a directional valve 1.

The fail-safe valve 2 is normally opened after the start of the operation of the vehicle, after which the front axle actuator 10 as well as the rear axle actuator 11 can be acted upon by hydraulic medium in a desirable fashion corresponding to the pressure level adjusted by means of the pressure regulating valves 8, 9. In this case, it is determined by the different position or appropriate positioning or switching of the directional valve 1 (known per se) in which direction these actuators 10, 11 are acted upon—that is, when hydraulic oscillating motors are used as actuators, which of the two mutually complementary working chambers of each oscillating motor are acted upon—.

If any type of disturbance occurs in the system and is recognized as such—particularly by monitoring or analyzing the signals of the two pressure sensors 5, 6—, the fail-safe valve 2 is closed; that is, is moved into a position interrupting the front axle forward flow line 12, which is illustrated in FIG. 1. As explained above, the fail-safe valve is not energized for this purpose so that advantageously it also arrives in this fail-safe position in the event of an undesirable interruption of its power supply.

As illustrated, if the fail-safe valve 2 is closed, hydraulic fluid arrives with the same pressure as that provided for the rear axle in a suction line 25, where it can reach a forward axle actuator line 18 or 19 by way of a return valve 3 depending on the position of the directional valve 1. Thus, when the fail-safe vale 2 is closed, hydraulic fluid at the same pressure level will reach the rear axle actuator 11 by way of the rear axle actuator line 20 or 21 as well as (as a function of the position of the directional valve 1) the front axle actuator 10 by way of the front axle actuator line 18 or 19, so that it is ensured that the pressure applied to the front axle actuator 10 is at least just as high as the hydraulic pressure applied to the rear axle actuator 11. This condition is advantageously always ensured when the fail-safe valve 2 is closed; that is, when it interrupts the front axle forward flow line 12; whether the fail-safe valve 2 takes up this (takes up this position? translator) as desired or in an undesirable manner, that is, because of an operating defect.

Irrespective of the position of the fail-safe valve 2 and thus also in the condition illustrated in FIG. 1, the hydraulic fluid flowing back from the rear axle actuator 11 can, by way of a return flow line 16, reach a return flow line 14 and can arrive from there in the tank 24. The hydraulic fluid flowing back from the front axle actuator 10 arrives, by way of a so-called throttle line 16 and a throttle 4 provided therein, by way of the adjoining throttle line 17, in the return flow line 14. Also, by way of these throttle lines 16, 17 with an appropriately designed throttle 4, when the fail-safe valve 2 is closed, that is, interrupts the front axle forward flow line 12, hydraulic medium can arrive from the tank 24 in the respectively connected chamber of the actuator 10, if a vacuum should exist there, so that cavitation is excluded.

In the position of the fail-safe valve 2 illustrated in FIG. 2, the solenoid 28 is acted upon by current so that the fail-safe valve 2 is open. As a result, hydraulic fluid at a pressure which, because of the pressure drop at the pressure regulating valve 8, is higher than that at the rear axle, can reach the front axle actuator 10, which represents the normal operating condition. Naturally, this prevents an opening of the return valve 3; that is, by way of the suction line 25, no exchange of hydraulic medium takes place between the rear axle forward flow line and the front axle forward flow line 12.

FIG. 3 shows an alternative embodiment of the present invention in which identical components have the same reference numbers. In contrast to the embodiments in FIGS. 1 and 2, an additional pressure sensor 6 is arranged here between the pump 23 and the fail-safe valve 2. Otherwise the method of operation corresponds to that described in FIGS. 1 and 2. By means of this pressure sensor 6, a self-diagnosis can be carried out, in which case, when the fail-safe valve 2 is closed, that is, is current-free, the operation of the pressure regulating valve 8 can be monitored or checked without any active rolling of the vehicle.

By means of the circuits according to the advantageous embodiments of FIGS. 1 to 3, a possibility is provided for monitoring the plausibility, in which, in contrast to the prior art, no additional expenditures are created. It is also pointed out that a large number of details may be constructed to deviate from the illustrated embodiment without leaving the content of the claims.

Reference Numbers

| | |
|---|---|
| 1 | Directional valve |
| 2 | fail-safe valve |
| 3 | return valve |
| 4 | throttle |
| 5 | front axle pressure sensor |
| 6 | front axle pressure sensor |
| 7 | rear axle pressure sensor |
| 8 | pressure regulating valve front axle |
| 9 | pressure regulating valve rear axle |
| 10 | front axle actuator |
| 11 | rear axle actuator |
| 12 | forward flow line front axle |
| 13 | return flow line |
| 14 | return flow line |
| 15 | return flow line |
| 16 | throttle line |
| 17 | throttle line |
| 18 | front axle actuator line |
| 19 | front axle actuator line |
| 20 | rear axle actuator line |
| 21 | rear axle actuator line |
| 22 | forward flow line rear axle |
| 23 | pump |
| 24 | tank |
| 25 | suction line |
| 26 | pressure line |
| 27 | pressure spring |
| 28 | solenoid |
| 29 | blocking position |
| 30 | pass position |

1. Hydraulic stabilizing system, particularly for a chassis of a vehicle, which has a tank (24) for hydraulic fluid and a pump (23) which are connected by way of corresponding hydraulic lines (12, 13, 14, 15, 16, 17, 18, 19, 20, 21, 22, 25, 26) with front and rear axle actuators (10,11), a directional valve (1) being connected in front of the actuators, and the pressure at the front axle actuator (10) being controllable such that it is greater than or equal to the pressure at the rear axle actuators,
wherein, between the directional valve (1) for the front axle actuator (10) and the pump (23), a fail-safe valve (2) is provided and, between the fail-safe valve (2) and the directional valve (1) in the front axle forward flow line (12), a pressure sensor (5) is provided.

2. Hydraulic stabilizing system according to claim 1, characterized in that the fail-safe valve (2) has a pass position (30) and a blocking position (29).

3. Hydraulic stabilizing system according to claim 1 or 2,
characterized in that a departing throttle line (16) with a throttle (4) is provided between the fail-safe valve (2) and the directional valve (1).

4. Hydraulic stabilizing system according to one of the preceding claims,
characterized in that a departing suction line (25) with a return valve (3) is provided between the fail-safe valve (2) and the directional valve (1).

5. Hydraulic stabilizing system according to claim 1 to 4,
characterized in that a pressure sensor (6) is provided between the pump (23) and the fail-safe valve (2).

6. Hydraulic stabilizing system according to one of the preceding claims,
characterized in that a pressure regulating valve (8) is arranged between the pump (23) and the rear axle actuators (11), and a pressure sensor (7) is arranged between the pressure regulating valve (8) and the rear axle actuator (11).
